(19) United States
(12) Patent Application Publication
(10) Pub. No.: US 2020/0378804 A1
(43) Pub. Date: Dec. 3, 2020

(54) GRATING DISC AND FEEDBACK SYSTEM

(71) Applicants: HAN'S LASER TECHNOLOGY INDUSTRY GROUP CO., LTD., Shenzhen (CN); SHENZHEN HAN'S SCANNER S&T CO., LTD., Shenzhen (CN)

(72) Inventors: BING DING, Shenzhen (CN); Hongyan Qin, Shenzhen (CN); Jihan Pan, Shenzhen (CN); Yuanfang Tan, Shenzhen (CN); Rongbo Wu, Shenzhen (CN); Yunfeng Gao, Shenzhen (CN)

(21) Appl. No.: 16/995,847

(22) Filed: Aug. 18, 2020

Related U.S. Application Data
(63) Continuation of application No. PCT/CN2019/083896, filed on Apr. 23, 2019.

(51) Int. Cl. G01D 5/38; G01D 5/347

(52) U.S. Cl. CPC G01D 5/38; G01D 5/3473; G01D 5/34707

(57) ABSTRACT

The present disclosure relates to a field of galvanometer, in particular to a grating disc and feedback system. The grating disc includes main gratings and zero-position gratings. The main gratings are disposed on different diameter positions, and the zero-position gratings are disposed close to the main gratings. A number of the zero-position gratings is 2N, the 2N zero-position gratings are distributed at an uniform angle with respect to a grating disc center. N is a positive integer. Compared with the prior art, the present disclosure provides the grating disc, which is matchable with a plurality of the encoders to use. The present disclosure further provides the feedback system, which increases detecting precision and stability of the grating disc and the encoders. In particular, anti-eccentricity capability and drift capability of a galvanometer motor system are improved, so that tolerance and anti-interference ability of the galvanometer motor to the environment are improved.

### CROSS REFERENCE OF RELATED APPLICATIONS

The present application is a continuation-application of International (PCT) Patent Application No. PCT/CN2019/083896 filed on Apr. 23, 2019, the entire contents of which are hereby incorporated by reference.

### TECHNICAL FIELD

The present disclosure relates to a field of galvanometer, in particular to a grating disc and a feedback system, which are applied to angle detection of galvanometer motors.

### BACKGROUND

In the fields of laser processing and optical scanning, guide controlling of laser and other scanning signals are realized by driving a mirror, reciprocating in a certain range or in a certain included angle via a rotating motor. This kind of the rotating motor that drives the mirror to high-speeds and high-precision swings is usually called a galvanometer motor. The galvanometer motor differs from a common motor because it is unable to rotate 360 degrees and is only able to swing within a certain angle, thus, zero-position scale lines of main gratings must appear within the field of view of the encoders during a process of movement. Furthermore, because the galvanometer motor controls an angle of deflection of a lens used to reflect light, there is an extremely high precision and responsiveness requirements.

Due to a fact that lights are reflected by a swinging mirror and can only reach a processed or detected surface after the light further propagates a relatively long distance, thus, positioning precision of the lights or other signals in the processed or detected surface is directly related to precision of the mirror swinging. Since the longer a distance, from the mirror to the processed surface, of the lights is, the greater magnification of a mirror swinging error is, the higher positioning precision requirement for the mirror is.

In general, one end of a rotating shaft of the galvanometer motor is directly connected with a reflector, and another end of the rotating shaft of the galvanometer motor is directly connected with the encoders which located on a position of a feedback motor. To improve positioning precision and repetition precision of the reflector, the precision of the encoder should be improved.

Moreover, in addition to effect of the encoders on rotating precision of the reflector, shaking of the rotating shaft in the process of the movement can also affect the rotating precision of the reflector.

In this way, there is a need to provide a grating disc and feedback system, which solves problems of the precision of the encoder and redial shaking of the rotating shaft to improve the rotating precision of the reflector.

### SUMMARY

An object of the present disclosure is to provide a grating disc and a feedback system to overcome defects of the prior art. Then problems like precision of reflectors influencing by shaking of a rotating shaft or the precision of the reflectors influencing by drifting a rotation center of the rotating shaft under different temperatures, vibrations and environments can be solved.

The present disclosure provides a grating disc to solve technical problems of the present disclosure, the grating disc includes main gratings and zero-position gratings. The main gratings are disposed on different diameter positions, and the zero-position gratings are disposed near the main gratings. A number of the zero-position gratings is 2N, and the 2N zero-position gratings are distributed at an uniform angle with respect to the grating disc center. N is a positive integer.

Furthermore, each of the main gratings includes a plurality of scale lines, and the plurality of the scale lines have an equal width and are arranged at equal intervals in an annular region of each of the main gratings/an arc-shaped region of each of the main gratings.

Furthermore, each the zero-position gratings includes a plurality of scale lines, and the plurality of the scale lines are arranged at unequal intervals in an arc-shaped region.

Furthermore, not all of widths of the scale lines are equal.

Furthermore, each of the zero-position gratings includes a plurality of scale lines, the plurality of the scale lines are arranged within an arc-shaped region, and not all of the widths of the scale lines are equal.

Furthermore, all of the zero-position gratings are all the same; or, some or all of the zero-position gratings are different with each other.

Furthermore, each of the zero-position gratings includes first zero-position gratings and second zero-position gratings, and the first zero-position gratings and the second zero-position gratings are disposed on different diameter positions.

The present disclosure further provides a feedback system to solve the technical problems of the present disclosure, the feedback system is applied to a rotating body and includes the grating disc, encoders, and a processing unit. The grating disc is fixedly disposed on the rotating body, a center of the grating disc and a rotating shaft of the rotating body are coaxially disposed. A number of the encoders is 2N, the 2N encoders are distributed at an uniform angle with respect to the grating disc center. The 2N encoders obtain positions of corresponding zero-position gratings to identify zero positions and obtain position changes of main gratings to identify rotation angles. N is a positive integer. The processing unit obtains the zero positions fed back by all of the encoders to achieve positioning of corresponding encoders and obtains the rotation angles fed back by all of the encoders to calculate an average rotation angle to determine an actual rotation angle of the grating disc.

Furthermore, a zero-position window group is disposed on a photoelectric receiving end of each of the encoders. The zero-position window group includes transparent windows and opaque windows. The transparent windows and the opaque windows are alternately disposed, and positions of the opaque windows are matched with scale lines of the zero-position gratings.

Furthermore, some or all of the zero-position gratings are different, and each of the encoders is paired with one zero-position grating.

Furthermore, the feedback system further includes a signal processing circuit. The signal processing circuit includes a filtering module, a sampling module, an operation module and a signal output module. The filtering module, the sampling module, the operation module, and the signal output module are sequentially disposed. The filtering module is connected with the encoders, and the processing unit is connected with the signal output module.

Furthermore, the rotating body is a rotating shaft of a galvanometer motor, and a center of the rotating shaft of the galvanometer motor and the center of the grating disc are coaxially disposed.

Compared with the prior art, the present disclosure provides the grating disc, which is matchable with a plurality of the encoders to use. The present disclosure further provides the feedback system, which increases detecting precision and stability of the grating disc and the encoders. In particular, anti-eccentricity capability and drift capability of a galvanometer motor system are improved, so that tolerance and anti-interference ability of the galvanometer motor to the environment are improved. Further, difficulty of installation and adjustment is reduced, and it is easier to detect products which is unqualified.

### BRIEF DESCRIPTION OF DRAWINGS

FIG. 1 is a principle schematic diagram of a concentricity error of a grating disc of the present disclosure.

FIG. 2 is a principle schematic diagram of a drift error of a grating disc of the present disclosure.

FIG. 3 is a structural schematic diagram of a grating disc of the present disclosure.

FIG. 4 is an enlarged structural schematic diagram of portion A of FIG. 3.

FIG. 5 is a structural schematic diagram of a zero-position grating of a first scheme of the present disclosure.

FIG. 6 is a structural schematic diagram of a zero-position grating of a second scheme of the present disclosure.

FIG. 7 is a structural schematic diagram of a zero-position grating of a third scheme of the present disclosure.

FIG. 8 is a structural schematic diagram of a grating disc based on four zero-position gratings of the present disclosure.

FIG. 9 is a structural schematic diagram of a grating disc based on eight zero-position gratings of the present disclosure.

FIG. 10 is a structural schematic diagram of a feedback system of the present disclosure.

FIG. 11 is a structural schematic diagram of a feedback system based on a signal processing circuit of the present disclosure.

FIG. 12 is a structural schematic diagram of a feedback system based on four encoders of the present disclosure.

FIG. 13 is a structural schematic diagram of a feedback system based on eight encoders of the present disclosure.

FIG. 14 is a principle schematic diagram of concentricity error compensating of a grating disc of the present disclosure.

FIG. 15 is a principle schematic diagram of drift error reducing of a grating disc of the present disclosure.

### DETAILED DESCRIPTION

The embodiments of the present disclosure are described below with referring to the accompanying drawings.

The present disclosure provides a grating disc and a feedback system, which solve problems of precision of encoders and radial shaking of a rotating shaft.

In general, there are two ways to improve the precision of the encoders. One way to improve the precision of the encoders is to adjust concentricity, end jump, and the like which are unsatisfactory of the encoders by assembly, such that an ideal rotation center is made to coincide with an actual rotation center as much as possible, and relative distance between a main grating and a photoelectric receiver is fixed, so that positioning precision is improved. However, based on a premise of certain adjustment devices, the precision of the encoders has an upper limit. Another way to improve the precision of the encoders is to improve overall precision by increasing numbers of scale lines of circular gratings of the encoders, resolution, and electronic subdivision rate. However, under a premise of a certain grating scribing processes, increasing the numbers of the scale lines means that diameters of the circular gratings must be increased, and an increase of the diameters of the circular gratings leads to an increase of rotational inertia, which affects a highest speed and acceleration capability of galvanometer swinging. The precision of the encoders still has an upper limit. Thus, there is the upper limit and a bottleneck for a method of improving the overall precision of the galvanometer from an encoder assembly and design precision. How to further improve precision of galvanometer motor products under certain premises of assembly technology and processing technology becomes a challenge.

In addition to effect of the encoders on rotation precision of reflectors, shaking of the rotating shaft in the motion process also affects the rotation precision of the reflectors. In general, rotation of the rotating shaft in the galvanometer motor is inseparable from cooperation of bearings, and there is a certain gap between balls and a track inside the bearings. Therefore, certain radial shaking results by a final actual rotation of the rotating shaft, which also affects the rotation precision of the reflectors. In addition to the shaking, under an effect of different temperatures, vibrations and environments, a rotation center of the rotating shaft is drift, and these drift finally affects repetition precision of the reflectors.

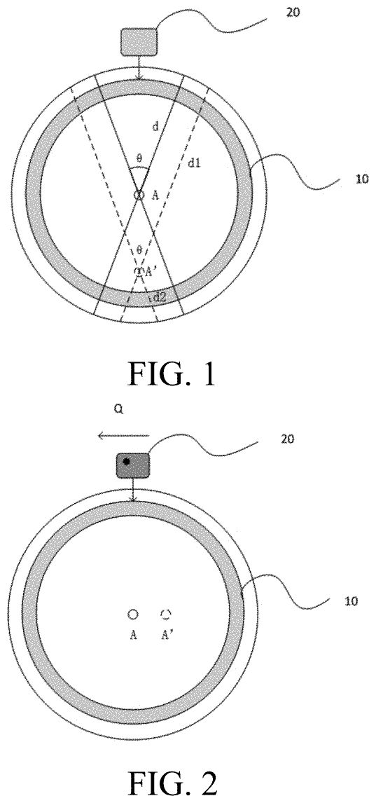

Specifically, regarding to a shaking problem, please refer to FIG. 1, FIG. 1 is a schematic diagram of a concentricity error between the grating disc 10 and the rotation center. Point A in FIG. 1 is an ideal center point of the grating disc 10 and an ideal rotation center of the grating disc 10, both of which are coincided. Point A′ is the actual rotation center caused by the assembly technology and the processing technology. When the galvanometer motor rotates a fixed angle θ (set as 25°), an optical radius d is 10 mm. Ideally, the grating disc 10 rotates around the ideal rotation center A, and an arc length L read by the encoder 20 is calculated by a following formula:

$$L = \frac{θ π d}{180} = \frac{25 \times 3.14 \times 10}{180} \approx 4.361$$

However, in actual measurements, the grating disc 10 rotates with respect to point A′ which concentricity is different with point A, assuming that the optical radius d1 is 12 mm, then the arc length L1 read by the encoder 20 is calculated as follow:

$$L 1 = \frac{θ π d 1}{180} = \frac{25 \times 3.14 \times 12}{180} \approx 5.233$$

It can be seen that if there is an error in the concentricity between the grating disc 10 and the rotation center, the arc length read by the encoder 20 is imprecise, so that a final rotation angle of the galvanometer motor has a large deviation if the final rotation angle of the galvanometer motor is calculated by pushing the formula of the arc length back.

Further, regarding to a drift problem, please refer to FIG. 2, FIG. 2 is a schematic diagram of a drift error of the rotation center. Assuming that a center of a code channel of the grating disc 10 coincides with the rotating shaft, the ideal rotation center is point A, but because there is a gap between the bearings, the actual rotation center drifts to point A′ under effects of factors such as temperatures, vibrations and the like. If the galvanometer motor does not actually move, reading of the encoders 20 changes due to drift of the rotation center. An arrow Q in FIG. 2 is an increasing direction of the reading of the encoders 20. When the rotation center shifts from point A to point A′, the reading of the encoders 20 is small with respect to the ideal reading, a value of a position feedback system drifts.

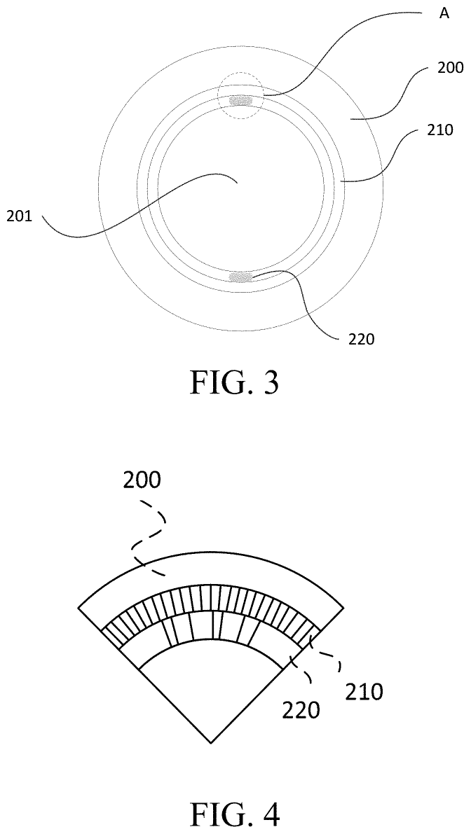

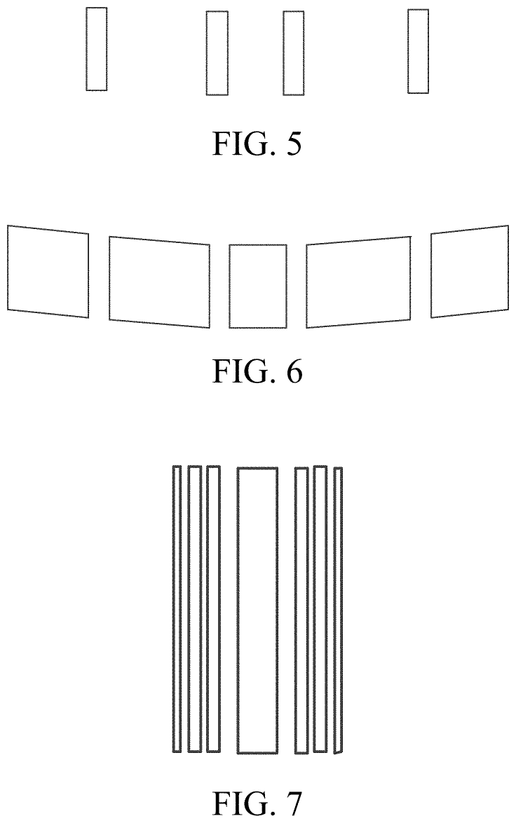

Please refer to FIGS. 3-4, the present disclosure provides one embodiment of the grating disc.

The grating disc 200 includes main gratings 210 and zero-position gratings 220. The main gratings 210 are disposed on different diameter positions, and the zero-position gratings 220 are disposed close to the main gratings 210. A number of the zero-position gratings 220 is 2N, and the 2N zero-position gratings 220 are distributed at an uniform angle with respect to a grating disc center 201. N is a positive integer. The main gratings 210 and the zero-position gratings 220 do not overlap. A concept of scale lines described below relate to words such as distance, interval, width, etc., which can be regarded as displacement or arc path distances between the scale line centers, as well as displacements or distances obtaining from other measurements.

A shape of the grating disc 200 is generally circular but not limited to be circular. For example, the grating disc 200 can be set to be rectangular, the scale lines are only disposed in a swing region of the grating disc 200, the code channel and a substrate, of a region, which is not read by an external encoder, are removed. The substrate is a main body of the grating disc 200, and the code channel is disposed on the substrate. And, a ring-shaped or an arc-shaped structure formed by the main gratings 210 and the zero-position gratings 220 is disposed with the grating disc center 201 as a center of a circle.

Further, the present disclosure provides two embodiments of the grating disc 200. In the first embodiment, the grating disc 200 includes a glass main body, a plurality of scale lines are engraved on a surface of the glass main body, the scale lines is an opaque part of the glass main body, and each smooth part of the glass main body disposed between each two scale lines is transparent. And the scale lines can be a metal coating or other scale line traces. In the second embodiment, the grating disc 200 includes a metal main body, the plurality of the scale lines are engraved on a surface of the metal main body, and each smooth metal surface disposed between each two scale lines reflects light. And, the metal main body is also formed by coating the glass main body with a metal layer.

Further, the present disclosure provides two embodiments of the main gratings 210. Please refer to FIG. 4, in the first embodiment, the main gratings 210 includes the plurality of the scale lines with an equal width and arranged at equal intervals in an annular region, a distance of the width and the interval is a grid distance, which is usually 20 um or 40 um, and is considered to be an arc-shaped track distance of a middle line. Thus, a circle of the main gratings 210 are disposed on the grating disc 200, and the center of the circle of the main grating 210 is the grating disc center 201. In the second embodiment, the main grating 210 includes the plurality of the scale lines with the equal width and interval in an arc-shaped region, the distance of the width and the interval is the grid distance, which is usually 20 um or 40 um, and is also considered to be the arc-shaped track distance of the middle line, and the scale lines of each of the main gratings 210 extend to two sides of a center of corresponding zero-position grating 220 with respect to the corresponding zero-position grating 220. Also, a length of the arc-shaped region depends on application environments of the grating disc, which is an angle of the round-trip rotation.

Further, the present disclosure provides embodiments of the zero-position gratings, please refer to FIGS. 5-7. In the first embodiment, each of the zero-position gratings includes the plurality of the scale lines, the plurality of the scale lines are arranged within an arc-shaped region, and not all of widths of the scale lines are equal. A width of each scale line and a width of each region adjacent to the scale line collectively form a “code”. As long as the width of each scale line or the width of each region adjacent to the scale line is changed, a new “code” is formed. The “code” is an unique identification code reflected the zero-position gratings 220, which is an identity card number belonging to the “codes”. Please refer to FIG. 5, each of the zero-position gratings 220 includes a plurality of scale lines arranged at unequal intervals in the arc-shaped region, and the widths of the scale lines are the same. Please refer to FIG. 6, each of the zero-position gratings 220 includes the plurality of the scale lines arranged at unequal intervals in the arc-shaped region, while not all of the widths of the scale lines are equal, that is, parts of the widths of the scale lines are equal or all of the widths of the scale lines are unequal.

In the second embodiment, please refer to FIG. 7, each of the zero-position gratings 220 includes the plurality of the scale lines, the plurality of the scale lines are arranged in the arc-shaped region, and not all of the widths of the scale lines are equal. There are two possibilities, the first possibility is that the width of each of the scale lines is equal, the second possibility is that not all of the width of each of the scale lines is equal.

In the third embodiment, each of the zero-position gratings 220 includes first zero-position gratings and second zero-position gratings, and the first zero-position gratings and the second zero-position gratings are disposed on different diameter positions. The positioning precision of the encoders is further improved by the first zero-position gratings and the second zero-position gratings, which reduces external interference. Examples employed by the first zero-position gratings and the second zero-position gratings refer to examples of the first embodiment and the second embodiment described above.

In one embodiment, the “code” is formed by the zero-position gratings 220, and various possibility studies is performed for setting problems of the “code”. Since the grating disc 200 of the present disclosure is applied in a special environment where reciprocating motion is achieved and the rotation angle is small, different “codes” are disposed on the grating disc 200 to prevent transition rotation of the grating disc 200. For example, some or all of the zero-position gratings 220 are different, where the different here refers to that “codes” are different. Optionally, “codes” of adjacent zero-position gratings 220 are different when N is greater than 1. And for example, all of the zero-position gratings are the same, which means that “codes” of the zero-position gratings are the same, only two zero-position gratings 220 are present when N is equal to 1. The grating disc 200 rotates the zero-position gratings 220 to an opposite angle, which is difficult and no need to employ different “coding” modes.

For a case where the number of the encoders needs to continue to be increased, it is necessary to consider a relationship between an actual swing angle of the galvanometer motor and an actual operating angle of each encoder. If the swing angle of the galvanometer motor is too large, the same one zero-position grating 220 appears to appear on two adjacent encoders at different angles, which needs to change the “code” of each zero position grating 220 or two adjacent zero-position gratings 220.

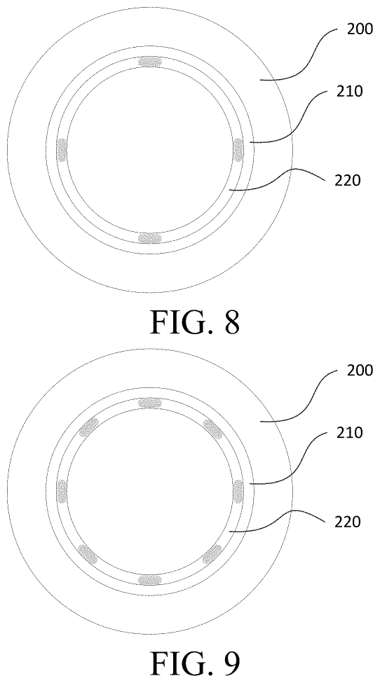

Please refer to FIG. 8, four zero-position gratings 220 are disposed on the grating disc 200, that is, N is 2, and an included angle of each zero-position grating 220 is 90 degrees. Please also refer to FIG. 9, eight zero-position gratings 220 are disposed on the grating disc 200, that is, N is 4, and the included angle of each zero-position grating 220 is 45 degrees.

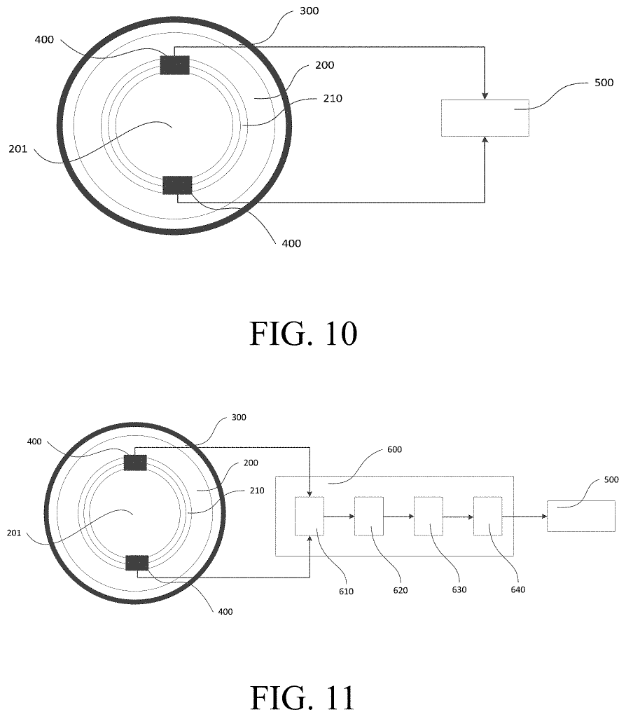

Please refer to FIG. 10, the present disclosure provides the feedback system.

The feedback system is applied to the rotating body, which includes the grating disc 200, encoders 400, and a processing unit 500. The grating disc 200 is fixedly disposed on the rotating body, and the center of the grating disc 200 which is the grating disc center 201 and a rotating shaft of the rotating body are coaxially disposed. A number of the encoders 400 is 2N, the 2N encoders 400 are distributed at an uniform angle with respect to the grating disc center 201. The 2N encoders 400 obtain positions of corresponding zero-position gratings 220 to identify zero positions and obtain position changes of the main gratings 210 to identify rotation angles. N is a positive integer.

And, when the rotating body is ready to run for rotation, in particular to the galvanometer motor, the center of the rotating shaft of the galvanometer motor and the center of the grating disc 200, which is the grating disc center 201, are coaxially disposed. Since the galvanometer motor only swing in one angle, which is usually ±12.5°, then the galvanometer motor needs to swing the rotating shaft back and forth to drive the grating disc 200 swing under the encoders 400 and drive the encoders 400 respectively find their own zero positions, then the encoders 400 start normal operation and record the rotation angle of the grating disc 200.

Specifically, when the eccentricity of the grating disc 200 occurs, readings of two encoders 400 in a same group appear one large and one small. After averaging, the actual rotation angle of the grating disc 200 is compensated, so that the reading of single encoder 400, which is too large or too small, is corrected. And, when the rotating shaft is displaced due to external reasons, the readings of encoder 400 appear an increase in one reading and a decrease in another reading. After averaging the readings of the two encoders 400 in the same group, a final reading is zeroed, which greatly reduces an effect of displacement of the rotation center on the result.

Further, a zero-position window group is disposed on a photoelectric receiving end of each of the encoders 400. The zero-position window group includes transparent windows and opaque windows. The transparent windows and the opaque windows are alternately disposed, and positions of the opaque windows are matched with scale lines of the zero-position gratings. Due to a fact that the galvanometer motor only swings and does not rotate one revolution, a zero-position signal is necessary to be separately disposed on a position where each encoder 400 is disposed, so that each encoder 400 finds the zero positions after power-on. Of course, a main grating window group is disposed on the photoelectric receiving end of each of the encoders 400. Similarly, the main grating window group further includes transparent windows and opaque windows. The transparent windows and the opaque windows are alternately disposed, and the transparent windows and the opaque windows are of an equal width.

Further, a placement direction of each encoder 400 relative to the grating disc 200 needs to be consistent, to ensure that when the grating disc 200 rotates in a certain direction, the readings of all the encoders 400 change in the same direction, that is, the readings of all the encoders increase or decrease simultaneously. It is impossible that one reading of the encoders increases while another reading of the encoders decreases.

Regarding to the processing unit 500, values of output signals of the encoders 400 are digitally summed and averaged, and a sum of all the readings of the encoders 400 is A, and is divided by a total number of encoders 400, which is 2N, to obtain a final rotation angle Φ of the galvanometer motor. The formula is as follow:

$$Φ = \frac{A}{2 N} .$$

Further, the zero-position windows of the encoders 400 are disposed directly above/under the zero-position gratings 220.

In one embodiment, the grating disc 200 includes the glass main body, the plurality of the scale lines are engraved on the surface of the glass main body, the scale lines are opaque parts of the glass main body, and the smooth part of the glass main body disposed between each two scale lines is transparent. The encoders 400 are transmissive encoder. The grating disc 200 includes a metal main body, the plurality of the scale lines are engraved on a surface of the metal main body, the scale lines are opaque parts of the metal main body, and the smooth part of the metal main body disposed between each two scale lines allows light to pass through. The encoders 400 are reflective encoders. Specifically, regarding to the transmissive encoders, the transmissive encoders emit parallel light of a certain wavelength band from a light source, the parallel light is transmitted vertically and then captured by the photoelectric receiver on another side of the light source, and the parallel light finally forms an interference moire fringe and converts to an electrical signal. Regarding to the reflective encoders, the reflective encoders emit the parallel light of the certain wavelength band from the light source, the parallel light enters a smooth metal surface at a certain angle and then is reflected by the smooth metal surface at a certain angle, and is finally captured by the photoelectric receiver on a same side of the light source to form the electricity signal. Further, the light source of the transmissive encoders is a light emitting diode (LED), and the light source of the reflective encoders is a laser diode (LD).

In one embodiment, the rotating body is a rotating shaft of the galvanometer motor.

During laser processing or optical signal scanning, the lights change a propagation direction by swinging the reflectors and finally reaches the surface of the processed or detected object. Precision of installation of the encoders 400 of the galvanometer motor, precision of processing and production of the encoders 400, the grating disc 200, and the photoelectric receiving component, and the radial shaking and drift generated when the rotating shaft of the galvanometer motor rotate, affect the rotation precision of the reflectors. And, a rotation error of the reflectors is further amplified by the reflected light path, which causes a processing light or a measurement light reaches the surface of the processed object is obviously deviated from a predetermined position.

The encoders 400 work together and a special grating disc 200 for multi-coding of the galvanometer motor is redesigned to ensure that each encoder 400 correctly identifies the zero positions. Then the encoders 400 are placed on the same grating disc 200 according to a specific position, assisting by a specific algorithm, and effects such as position errors occurred at final output, the eccentricity weaken, the galvanometer motor radially shaking and drifting and the like, are reduced.

Please refer to FIG. 11, the present disclosure provides one embodiment of a a signal processing circuit.

The feedback system further includes the signal processing circuit 600. The signal processing circuit 600 includes a filtering module 610, a sampling module 620, an operation module 630, and a signal output module 640. The filtering module 610, the sampling module 620, the operation module 630, and the signal output module 640 are sequentially disposed. The filtering module 610 is connected with the encoders 400, and the processing unit 500 is connected with the signal output module 640.

The output signals of the encoders 400 may be analog sine-cosine signals, square wave ABZ signals, pulse signals, digital protocol signals, etc. In the signal processing circuit 600, the signals are filtered, sampled, and calculated, and then a final position of the signals are outputted through the signal output module 640. The output signals include the analog signals, the square wave ABZ signals, the digital protocol signals and other types of signals. A final signal passes signal transmission cables are and is delivered to a back-end processing equipment such as a driver.

Further, regarding to an analog quantity addition method, an output quantity of the encoders 400 is changed to an analog quantity, and modulation precision of the encoders 400 is strictly controlled, so that signal phases outputted by all the encoders 400 are the same, the signals outputted by all the encoders 400 are stacked in parallel, finally all the groups of the encoders 400 are simultaneously transmitted to the signal processing circuit 600, the signals are filtered and sampled, and the final position is calculated.

In one embodiment, the signal processing circuit 600 may be a separate circuit board, may also be integrated in a circuit board of the encoders 400, or may be a circuit board of an integrated driver. Further, an algorithm of the signal processing circuit board for the signal processing circuit 600 is calculated by a separate chip, or calculated by a main control chip of an external motor drive board, or calculated by a chip built in the encoders 400.

For example, signal processing methods include a digital method and an analog method. Digital averaging is to add all the readings of the encoders 400 and a sum of the readings are divided by encoders 400 to obtain an average value. Analog averaging needs to strictly control an installation position of the encoders 400 of a same group, so that the analog sine-cosine signals obtained by the photoelectric receiver of the encoders 400 have a same phase and a same direction, and are completely stacked in parallel. the stacked signals of each group are finally transmitted to the signal processing circuit 600.

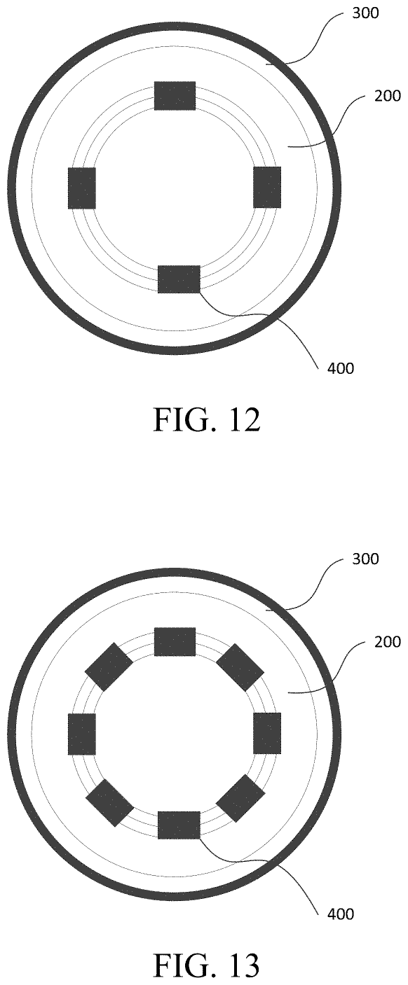

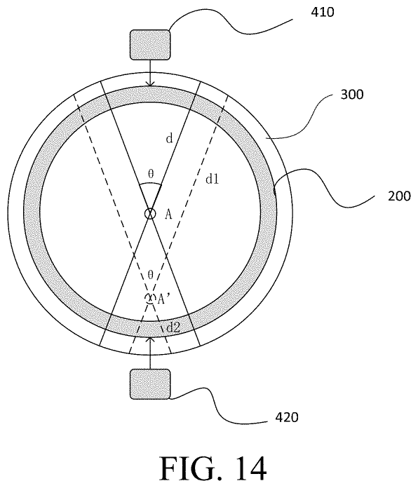

Please refer to FIGS. 12-13, the present disclosure provides embodiment of the encoders. Generally, one or two groups of encoders 400 are arranged, and each group has two encoders 400 disposed symmetrically at 180 degrees. And more than two groups or even more encoders 400 may be arranged according to precision requirements. An angle between each group of the two encoders 400 must satisfy a requirement of 180°. If there are a total of 2N encoders 400, an angle θ between each encoder 400 satisfies a formula:

$$θ = \frac{360}{2 N} .$$

When multiple encoders 400 are disposed, if the swing angle of the galvanometer is greater than 360/4N, there may be a risk that two zero positions appear in a swing range. Therefore, the zero-position signals at different positions are distinguished by corresponding the zero-position gratings at each position to prevent multiple zero positions appearing in the swing range.

Please refer to FIG. 14, the present disclosure provides embodiments of concentricity error compensating of the grating disc. Point A is an ideal center point of the grating disc 200 and the ideal rotation center the grating disc 200, both of which are coincided normally. Point A′ is the actual rotation center caused by the assembly technology and the processing technology. When the galvanometer motor rotates the fixed angle θ (set as 25°), the optical radius d is 10 mm. When the grating disc 200 rotates around the point A′ which concentricity is different, the optical radius d1 is assumed as 12 mm, then the arc length L1 read by the encoder 400 is calculated as follow:

$$L 1 = \frac{θ π d 1}{180} = \frac{25 \times 3.14 \times 12}{180} \approx 5.233$$

While the optical radius d2 is 8 mm, the arc length L2 measured by the encoder 420 of an opposite angle is calculated as follow:

$$L 2 = \frac{θ π d 2}{180} = \frac{25 \times 3.14 \times 8}{180} \approx 3.489$$

By averaging the L1 and the L2, a final arc length L′ is calculated as follow:

$${L}^{′} = \frac{L 1 + L 2}{2} = 4.367$$

Ideally, when the center point of the grating disc 200 coincides with the rotation center, the grating disc 200 rotates around the ideal rotation center A, and the arc length L read by the encoder is calculated by the following formula:

$$L = \frac{θ π d}{180} = \frac{25 \times 3.14 \times 10}{180} \approx 4.361$$

It can be seen that, for the galvanometer motor 300, the error caused by the concentricity problem of the grating disc 200 has a good inhibition effect.

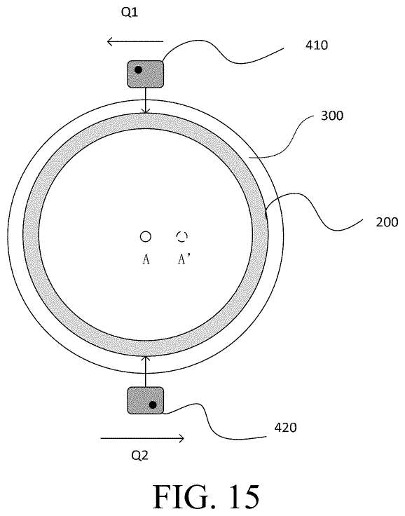

Please refer to FIG. 15, the present disclosure provides embodiments of drift error reducing of the grating disc

Assuming that the center of the code channel of the grating disc 200 coincides with the rotating shaft, the ideal rotation center is point A, but because there is a gap between the bearings, the actual rotation center drifts to point A′ under factors such as temperatures, vibrations and the like.

If the galvanometer motor does not actually move, the readings of the encoder 410 and the encoder 420 are changed due to the drift of the rotation center. The arrow Q1 and the arrow Q2 in FIG. 15 are respectively the increasing directions of the readings of the encoders. When the rotation center shifts from point A to point A′, the reading of the encoder 410 is small with respect to the ideal reading, and the reading of the encoder 420 becomes large. Therefore, when only one encoder is arranged, the value of the position feedback system drifts. However, averaging the values of the two encoders (410, 420) makes increasing and decreasing of the reading cancel each other so that a final position data remains unchanged. This is related to positions of the two encoders specially arranged in a diameter direction.

For drift in a specific direction, only two encoders of diagonals, which are perpendicular to a vector of the specific direction, play a maximum role. Thus, if there is a need to cancel drift in multiple directions, multiple groups of the encoders are needed for support. Due to a particularity of a motion of the galvanometer motor 300, the galvanometer motor 300 keeps swinging within a certain angle, which is usually ±12.5°, but never rotates for an entire circle, so that the least one group which includes two encoders can substantially cancel a drift error.

It should be understood that the specific embodiments described herein are only used to explain the present disclosure and are not intended to limit the present disclosure. Equivalent changes or modifications made by a scope of the present disclosure are covered by the present disclosure.

What is claimed is:

1. A grating disc, comprising main gratings and zero-position gratings, wherein the main gratings are disposed on different diameter positions, and the zero-position gratings are disposed close to the main gratings; a number of the zero-position gratings is 2N, the 2N zero-position gratings are distributed at an uniform angle with respect to a grating disc center; wherein N is a positive integer.

2. The grating disc according to claim 1, wherein each of the main gratings comprises a plurality of scale lines, and the plurality of the scale lines have an equal width and are arranged at equal intervals within an annular region of each of the main gratings/an arc-shaped region of each of the main gratings.

3. The grating disc according to claim 1, wherein each of the zero-position gratings comprises a plurality of scale lines, and the plurality of the scale lines are arranged at unequal intervals in an arc-shaped region of each of the zero-position gratings.

4. The grating disc according to claim 3, wherein not all of widths of the scale lines are equal.

5. The grating disc according to claim 1, wherein each of the zero-position gratings comprises a plurality of scale lines, the plurality of the scale lines are arranged within an arc-shaped region of each of the zero-position gratings, and not all of widths of the scale lines are equal.

6. The grating disc according to claim 1, wherein all of the zero-position gratings are all the same; or, some or all of the zero-position gratings are different from each other.

7. The grating disc according to claim 1, wherein each of the zero-position gratings comprises first zero-position gratings and second zero-position gratings, and the first zero-position gratings and the second zero-position gratings are disposed on different diameter positions.

8. The grating disc according to claim 6, wherein each of the zero-position gratings comprises first zero-position gratings and second zero-position gratings, and the first zero-position gratings and the second zero-position gratings are disposed on different diameter positions.

9. A feedback system, applied to a rotating body, comprising:
a grating disc, fixedly disposed on the rotating body; wherein a center of the grating disc and a rotating shaft of the rotating body are coaxially disposed; the grating disc comprises main gratings and zero-position gratings; the main gratings are disposed on different diameter positions, and the zero-position gratings are disposed close to the main gratings; a number of the zero-position gratings is 2N, the 2N zero-position gratings are distributed at an uniform angle with respect to a grating disc center;
encoders, wherein a number of the encoders is 2N, the 2N encoders are distributed at an uniform angle with respect to a center of the grating disc; the 2N encoders obtain positions of corresponding zero-position gratings to identify zero positions and obtain position changes of main gratings to identify rotation angles; wherein N is a positive integer; and
a processing unit, obtaining the zero positions fed back by all of the encoders to achieve positioning of corresponding encoders and obtaining the rotation angles fed back by all of the encoders to calculate an average rotation angle to determine an actual rotation angle of the grating disc.

10. The feedback system according to claim 9, wherein a zero-position window group is disposed on a photoelectric receiving end of each of the encoders; the zero-position window group comprises transparent windows and opaque windows; the transparent windows and the opaque windows are alternately disposed; and positions of the opaque windows are matched with scale lines of the zero-position gratings.

11. The feedback system according to claim 9, wherein some or all of the zero-position gratings are different, and each of the encoders is paired with one zero-position grating.

12. The feedback system according to claim 9, wherein the feedback system further comprises a signal processing circuit; wherein the signal processing circuit comprises a filtering module, a sampling module, an operation module, and a signal output module; the filtering module, the sampling module, the operation module, and the signal output module are sequentially disposed; the filtering module is connected with the encoders, and the processing unit is connected with the signal output module.

13. The feedback system according to claim 9, wherein the rotating body is a rotating shaft of a galvanometer motor, and a center of the rotating shaft of the galvanometer motor and the center of the grating disc are coaxially disposed.

14. The feedback system according to claim 9, wherein each of the main gratings comprises a plurality of scale lines, and the plurality of the scale lines have an equal width and are arranged at equal intervals within an annular region of each of the main gratings/an arc-shaped region of each of the main gratings.

15. The feedback system according to claim 9, wherein each of the zero-position gratings comprises a plurality of scale lines, and the plurality of the scale lines are arranged at unequal intervals in an arc-shaped region of each of the zero-position gratings.

16. The feedback system according to claim 15, wherein not all of widths of the scale lines are equal.

17. The feedback system according to claim 9, wherein each of the zero-position gratings comprises a plurality of scale lines, the plurality of the scale lines are arranged within an arc-shaped region of each of the zero-position gratings, and not all of widths of the scale lines are equal.

18. The feedback system according to claim 9, wherein all of the zero-position gratings are all the same; or, some or all of the zero-position gratings are different from each other.

19. The feedback system according to claim 9, wherein each of the zero-position gratings comprises first zero-position gratings and second zero-position gratings, and the first zero-position gratings and the second zero-position gratings are disposed on different diameter positions.

20. The feedback system according to claim 18, wherein each of the zero-position gratings comprises first zero-position gratings and second zero-position gratings, and the first zero-position gratings and the second zero-position gratings are disposed on different diameter positions.
